(19) United States
(12) Patent Application Publication
(10) Pub. No.: US 2004/0263505 A1
(43) Pub. Date: Dec. 30, 2004

(54) Display device

(76) Inventors: Masaki Tsubokura, Mobara (JP); Shunichi Matsumoto, Chiba (JP); Kazuhiko Yanagawa, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/875,334

(22) Filed: Jun. 25, 2004

(30) Foreign Application Priority Data
Jun. 27, 2003 (JP) 2003-183851

(51) Int. Cl. G09G 5/00

(52) U.S. Cl. 345/204

(57) ABSTRACT

A display device includes a display element, a printed circuit board which is arranged on a periphery of the display element and a flexible printed circuit board which connects the display element and the printed circuit board. The display device also includes a first frame which is arranged above the printed circuit board and a second frame which is arranged below the printed circuit board. Further, the display device includes buffer members which are fixed to either one of the first frame or the second frame and face the printed circuit board.

### BACKGROUND OF THE INVENTION

The present invention relates to a display device; and, more particularly, to the manner of support of a display panel in a frame member.

A typical panel-type display device of known construction has a region in which a matrix array of display pixels is formed in an opening portion of a frame, printed circuit boards are arranged in a periphery thereof and are disposed below the frame, and the printed circuit boards and the pixels of the display region are connected with each other by a flexible printed circuit board.

Driving signals are supplied to the pixels from the printed circuit boards via a flexible printed circuit board. The driving signals are converted into a proper voltage or a proper current for allowing the pixel array to produce a display using the following components depending on selected semiconductor element mounting methods. That is, in a TCP method in which a semiconductor element is formed on the flexible printed circuit board, the semiconductor element is used for the conversion of a driving signal to be applied to the display element. In a so-called COG method, in which a semiconductor element is formed over the pixel array, the signal from the flexible printed circuit board is converted into a proper current or a proper voltage using the semiconductor element, which is operated in response to a signal received from the flexible printed circuit board. Further, when a group of circuits which are formed of a thin film are formed on the periphery of the pixel array in the same manner as TFTs, the group of circuits is used for the conversion of the applied driving signal.

With respect to the relationship between the printed circuit board and the frame, as one example, a structure which laminates and fixes the frame and the board together using a tape is disclosed in Japanese Laid Open H11(1999)-142872.

### SUMMARY OF THE INVENTION

In the arrangement disclosed in Japanese Laid Open H11(1999)-142872, the structure which laminates and fixes the frame and the board to each other using a tape is disclosed in FIG. 2 thereof. However, along with an increase in the a size of the opening portion, that is, along with an expansion of the display region, it has become evident that a new drawback arises due to a difference in the thermal expansion coefficient between the printed circuit board and the display element. That is, unless the material of the display element and the material of the printed circuit boards are completely equal, a difference in thermal expansion coefficient unavoidably will exist between these two members. Accordingly, it has become apparent that there arises a difference in the degree of elongation and shrinkage between the display element and the printed circuit boards due to a temperature change and stress, which are generated between the display element and the printed circuit boards via the flexible printed circuit board. It has been also revealed that, due to the presence of such stress, a strain is generated in the display element and, hence, the stress has an influence on the image quality through a change in the contrast or the like.

Here, since the frame and the printed circuit board are fixed to each other in the arrangement disclosed in Japanese Laid Open H11(1999)-142872, it is difficult to alleviate the stress at the printed circuit board side. Accordingly, it has been found that the structure has a drawback in that the influence that the stress gives to the image quality is increased, and this causes a practical problem in the actual use of a large-sized printed circuit board.

To make the thermal expansion coefficients of the display element and the printed circuit board completely agree with each other is extremely difficult when they are made of different materials. It is an advantage of the present invention to provide a structure which can alleviate this stress.

A summary of representative aspects of the invention disclosed in this specification will be presented in the following Examples.

(1) A first aspect of the present invention is characterized in that, for example, a display device includes a display element, a printed circuit board which is arranged on a periphery of the display element and a flexible printed circuit board which connects the display element and the printed circuit board, and the display device includes a first frame which is arranged above the printed circuit board and a second frame which is arranged below the printed circuit board, wherein the display device further includes buffer members which are fixed to either one of the first frame and the second frame and face the printed circuit board.

(2) Another aspect of the present invention is characterized in that, on the premise of the constitution of Example (1), for example, the buffer members are alternatively arranged on an upper side and a lower side of the printed circuit board.

(3) Another aspect of the present invention is characterized in that, on the premise of the constitution of Example (1), for example, the printed circuit board includes two members which extend in parallel and the buffer members are alternately arranged with respect to the left and the right members.

(4) Another aspect of the present invention is characterized in that, on the premise of the constitution of Example (1), for example, the printed circuit board includes two members which extend in parallel and the buffer members are alternately arranged with respect to the left and the right members.

(5) Another aspect of the present invention is characterized in that, on the premise of the constitution of Example (1), for example, the display device includes chip members which are arranged on an upper surface or a lower surface of the printed circuit board and the buffer members are arranged while avoiding regions for forming the chip members.

(6) Another aspect of the present invention is characterized in that, for example, the display device includes a display element and a printed circuit board which is connected with the display element by a flexible printed circuit board, the display device includes a first frame which is arranged above the display element and a second frame which is arranged below the display element, and the display device includes buffer members which are fixed to either one of the first frame or the second frame and are brought into contact with the display element.

(7) Another aspect of the present invention is characterized in that, for example, a display device includes a display element, a printed circuit board which is arranged on a periphery of the display element and a flexible printed circuit board which connects the display element and the printed circuit board, wherein the printed circuit board is movable and an amount of the movement is restricted.

(8) Another aspect of the present invention is characterized in that, on the premise of any one of the constitutions of Examples (1) to (6), for example, the buffer members are made of nonwoven fabric.

(9) Another aspect of the present invention is characterized in that, on the premise of the constitution of Example (8), for example, the buffer members have an elongated rectangular shape and end portions thereof are formed in an arcuate shape.

(10) Another aspect of the present invention is characterized in that, on the premise of the constitution of Examples (8) or (9), for example, the extending direction of fibers of the buffer members is at the extending direction side of the printed circuit board.

(11) Another aspect of the present invention is characterized in that, on the premise of any one of the constitutions of Examples (1) to (6), for example, the buffer member has the multilayered structure and a frictional coefficient of surfaces of the buffer members which opposingly face the printed circuit board or the display element is smaller than a frictional coefficient of surfaces of the buffer members which are opposite to the opposingly facing surfaces.

(12) Another aspect of the present invention is characterized in that, on the premise of any one of the constitutions of Examples (1) to (6), for example, the buffer member has the multilayered structure and surfaces of the buffer members which opposingly face the printed circuit board or the display element are made of a material having an elongation and shrinkage property lower than an elongation and shrinkage property of surfaces of the buffer members which are opposite to the opposingly facing surfaces.

(13) Another aspect of the present invention is characterized in that, on the premise of any one of the constitutions of Examples (1) to (6), for example, the buffer member has the multilayered structure and surfaces of the buffer members which opposingly faces the printed circuit board or the display element is made of plastic and surfaces of the buffer members which are opposite to the opposingly facing surfaces is made of rubber.

(14) Another aspect of the present invention is characterized in that, on the premise of any one of the constitutions of Examples (1) to (6), for example, the buffer members are made of a foamed member.

(15) Another aspect of the present invention is characterized in that, on the premise of any one of the constitutions of Examples (1) to (6), for example, the buffer members are made of rubber which mixes beads in the inside thereof.

(16) Another aspect of the present invention is characterized in that, for example, a display device includes a display element and support members which are arranged on a periphery of the display element, and smoothers are provided between end surfaces of the display element and the support members.

(17) Another aspect of the present invention is characterized in that, on the premise of the constitution of Example (16), for example, the smoothers are provided between an end portion of the display element and the support members.

(18) Another aspect of the present invention is characterized in that, on the premise of the constitution of Examples (16) or (17), for example, a height of surfaces of the support members which opposingly face the display element is set larger than a height of the display element, and the smoothers are arranged at the support member side.

(19) Another aspect of the present invention is characterized in that, on the premise of any one of the constitutions of Examples (16) to (18), for example, the smoothers are formed on a lower side of the display device.

(20) Another aspect of the present invention is characterized in that, on the premise of any one of the constitutions of Examples (16) to (19), for example, materials of the display element and the support members are different from each other.

(21) Another aspect of the present invention is characterized in that, on the premise of any one of the constitutions of Examples (16) to (20), for example, the smoothers are formed in a tape shape.

The present invention is not limited to the above-mentioned constitutions and various modifications are conceivable without departing from the technical concept of the present invention.

### BRIEF DESCRIPTION OF THE DRAWINGS

FIG. 1A and 1B are plan views showing the upper frame and the intermediate frame, respectively, in a liquid crystal display device according to the present invention;

FIG. 2A and 2B are cross-sectional views taken along lines a-a and b-b, respectively, in FIGS. 1A and 1B, showing one embodiment of the liquid crystal display device according to the present invention;

FIG. 3A and 3B are cross-sectional views taken along line a-a and b-b, respectively, in FIGS. 1A and 1B, showing a second embodiment of the liquid crystal display device according to the present invention;

FIG. 4A and 4B are cross-sectional views taken along line a-a and b-b, respectively, in FIGS. 1A and 1B, showing a third embodiment of the liquid crystal display device according to the present invention;

FIG. 5A and 5B are cross-sectional views taken along line a-a and b-b, respectively, in FIGS. 1A and 1B, showing a fourth embodiment of the liquid crystal display device according to the present invention;

FIG. 6A to 6C are diagrams which show a plan view and a cross-sectional view, respectively, of one member suitable for use in the liquid crystal display device according to the present invention;

FIG. 7A and 7B are diagrams which show a plan view and a cross-sectional view, respectively, of one member suitable for use in the liquid crystal display device according to the present invention;

FIG. 8A and 8B are diagrams which show a plan view and a cross-sectional view, respectively, of one member suitable for use in the liquid crystal display device according to the present invention;

FIG. 9A is a cross-sectional diagram which shows an example of the layout of elements of the liquid crystal display device according to the present invention, and FIGS. 9B to 9E are cross-sectional views taken along line a-a in FIG. 9A;

FIG. 10A and 10B are plan views showing the upper frame and the intermediate frame, respectively, in another arrangement of the liquid crystal display device according to the present invention;

FIG. 11A and 11B are cross-sectional views taken along line a-a and b-b, respectively, in FIGS. 10A and 10B, showing a seventh embodiment of the liquid crystal display device according to the present invention;

FIG. 12A and 12B are cross-sectional views taken along lines a-a and b-b, respectively, in FIGS. 10A and 10B, showing an eight embodiment of the liquid crystal display device according to the present invention;

FIG. 13A is a cross-sectional view taken along line a-a in FIG. 1A, and FIG. 13B is an enlarged sectional view of a portion of FIG. 13A, showing a ninth embodiment of the liquid crystal display device according to the present invention;

FIG. 14 is a cross-sectional view showing a tenth embodiment of the liquid crystal display device according to the present invention;

FIG. 15A to 15C are cross-sectional views taken along line a-a in FIGS. 1A and 1B, showing an eleventh embodiment of the liquid crystal display device according to the present invention;

FIG. 16 is a cross-sectional view showing another embodiment of the liquid crystal display device according to the present invention; and

FIG. 17 is a diagrammatic plan view of a thin-type liquid crystal display device to which the present invention may be applied.

### DETAILED DESCRIPTION OF THE INVENTION

Preferred embodiments of a liquid crystal display device according to the present invention will be explained in conjunction with drawings.

### Embodiment 1

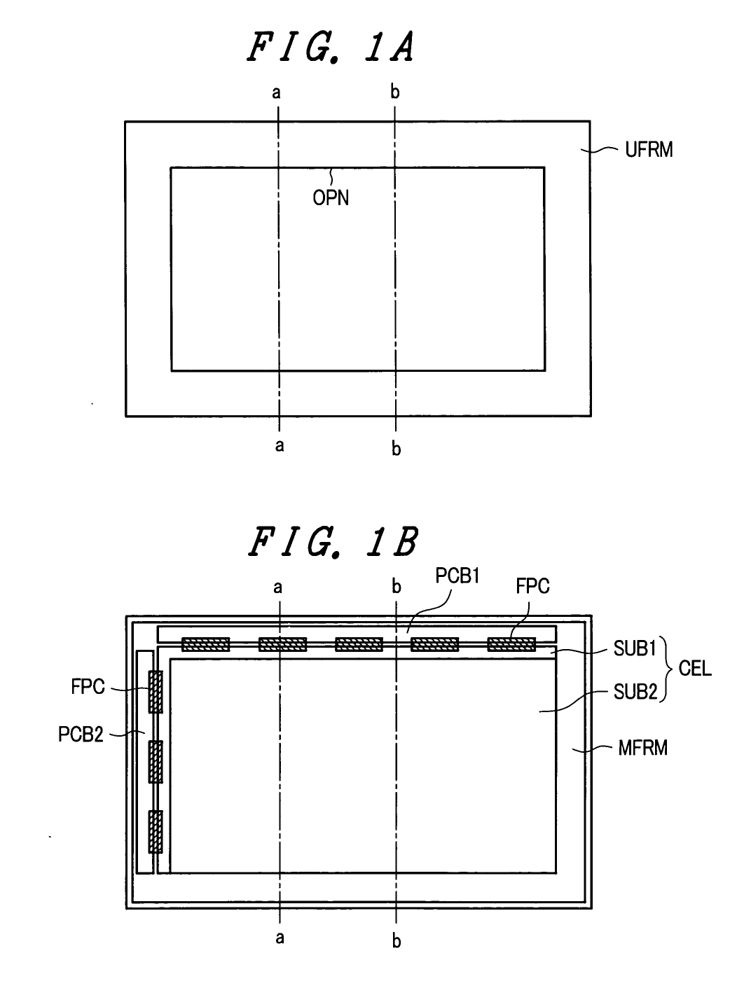

FIG. 1A is a plan view showing an upper frame of the liquid crystal display device according to the present invention. An opening portion OPN is formed in the upper frame UFRM, and a display image is formed in the inside of the opening portion OPN. FIG. 1B shows an intermediate frame of the liquid crystal display device in a state in which the upper frame UFRM is removed. A display element CEL, which is formed of the substrates SUB1 and SUB2, is arranged within the frame UFRM. The display element CEL is mounted on and supported by an intermediate frame MFRM.

On a periphery of the display element CEL, a printed circuit board PCB1 is arranged in the long-side direction and a printed circuit board PCB2 is arranged in the short-side direction, as seen in FIG. 1B, whereby the printed circuit boards PCB1, PCB2 extend substantially parallel to the long-side direction and the short-side direction of the display element CEL, respectively. Wiring on the display element CEL is electrically connected with the printed circuit board PCB1 using a flexible printed circuit board FPC. In the same manner, in this embodiment, wiring on the display element CEL and wiring on the printed circuit board PCB2 are electrically connected using a flexible printed circuit board FPC.

Further, driving signals are supplied to the display element CEL from at least one of the printed circuit boards PCB1 and PCB2 via the flexible printed circuit board FPC. The driving signals are converted into a proper voltage or a proper current to realize a display produced by the display element CEL using semiconductor elements in a TCP method in which the semiconductor element is mounted on the flexible printed circuit board FPC, using a semiconductor element in response to signals received from the flexible printed circuit board FPC in a so-called COG method in which forms the semiconductor element is formed on the display element CEL, or using a group of circuits when the group of circuits are formed of thin films in the same manner as a TFT in a peripheral portion of the display element CEL.

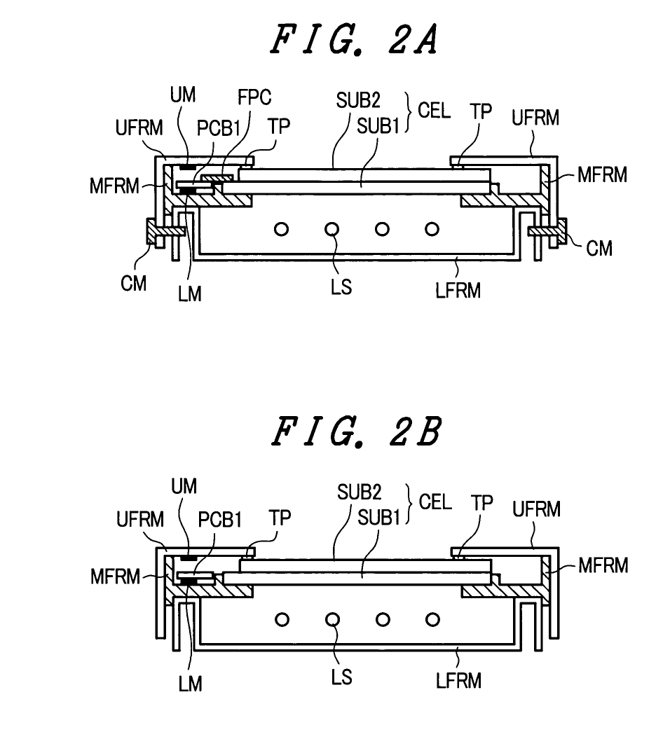

FIG. 2A and FIG. 2B show the cross-sectional structures of essential parts taken along a line a-a and a line b-b, respectively, in FIG. 1B, for example. The display element CEL is mounted on the intermediate frame MFRM. The printed circuit board PCB1, which is arranged on the periphery of the display element CEL, is depicted on the left side as seen in the drawing. The difference between the structure shown in FIG. 2A and the structure shown in FIG. 2B lies in the presence or non-presence of a region where the flexible printed circuit board FPC is present between the printed circuit board PCB1 and the display element CEL as a result of the different cross-sections being depicted. Further, although the cross-section which is parallel to the end side is shown to facilitate an explanation of the drawing, the same technical concept is applicable to a cross section that is parallel to the long sides. In such a case, the printed circuit board PCB1 shown in the drawing would be referred to as the printed circuit board PCB2.

The printed circuit board PCB1 and the display element CEL are connected with each other using the flexible printed circuit board FPC. The intermediate frame MFRM has a projecting region on an upper side thereof which is brought into contact with the upper frame UFRM in the region, as shown in the drawing. Due to such a provision, the positional relationship between the upper frame UFRM and the intermediate frame MFRM is determined. On the other hand, a light source LS is arranged below the display element CEL and a lower frame LFRM is arranged on a back surface of the light source LS. The light source LS may be formed of either fluorescent lamps or light emitting diodes. Further, the light source LS may be arranged below the display element CEL, or it may be arranged at a side surface of a light guide plate, such that light can be irradiated to the display element CEL through the light guide plate.

The intermediate frame MFRM is arranged in a state such that a flat portion thereof is brought into contact with a peripheral flat portion formed on an upper surface of the lower frame LFRM. Due to such a provision, the positional relationship between the intermediate frame MFRM and the lower frame LFRM is determined. By connecting the upper frame UFRM and the lower frame LFRM using connecting members CM, the upper frame UFRM, the intermediate frame MFRM and the lower frame LFRM are integrally formed and fixed to each other. By adopting such a fixing method, assembling and dismounting can be easily performed, thus providing a structure that is suitable for recycling. Although screws are used as the connecting members CM in this embodiment, any parts can be used provided that the parts have a connecting function.

A tape member (spacer) TP is arranged between the display element CEL and the upper frame UFRM. With the use of the tape member TP, the upper frame UFRM and the display element CEL are fixed to each other. Further, the display element CEL is mounted on the intermediate frame MFRM. Due to such a constitution, the display element CEL can be fixed in position by the upper frame UFRM and the intermediate frame MFRM.

On the intermediate frame MFRM, projecting portions which project upwardly are formed at a position close to an end portion of the display element CEL. In the drawing, a portion of the intermediate frame MFRM is arranged between the display element CEL and the printed circuit board PCB1 or PCB2. Due to such an arrangement, the position of the display element CEL in the horizontal direction is determined.

Below the printed circuit board PCB1 or PCB2, a lower member LM is arranged at the intermediate frame MFRM side. Above the printed circuit board PCB1 or PCB2, an upper member UM is arranged at the upper frame UFRM side. The lower member LM and the upper member UM are formed of a material other than a metal, wherein the lower member LM is fixed only to the intermediate frame MFRM side and the upper member UM is fixed only to the upper frame UFRM side. Due to such a constitution, the printed circuit board PCB1 or PCB2 is supported between the upper member UM and the lower member LM in such a way that the printed circuit board PCB1 or PCB2 is slightly movable in the vertical direction. Since the excessive movement of the printed circuit board PCB1 or PCB2 is restricted by the upper member UM and the lower member LM, a drawback which may arise due to excessive movement thereof can be structurally obviated.

In accordance with the method in which the printed circuit board and the frame are laminated using tape, that is, in the method in which the printed circuit board is fixed in position, as disclosed in Japanese Unexamined Patent Publication Hei11(1999)-142877, a strain which is generated due to the difference in thermal expansion coefficient between the display element CEL and the printed circuit board PCB1 is imparted to the display element CEL, thus leading to a lowering of the contrast, a lowering of the brightness and a lowering of the reliability with respect to a large-sized display device. However, in this embodiment, since the printed circuit board PCB1 is slightly movable, the difference in thermal expansion coefficient can be alleviated, and the influence of strain on the display element CEL can be alleviated. Due to such a constitution, the above-mentioned drawback can be suppressed, and, hence, the image quality and the reliability can be enhanced.

### Embodiment 2

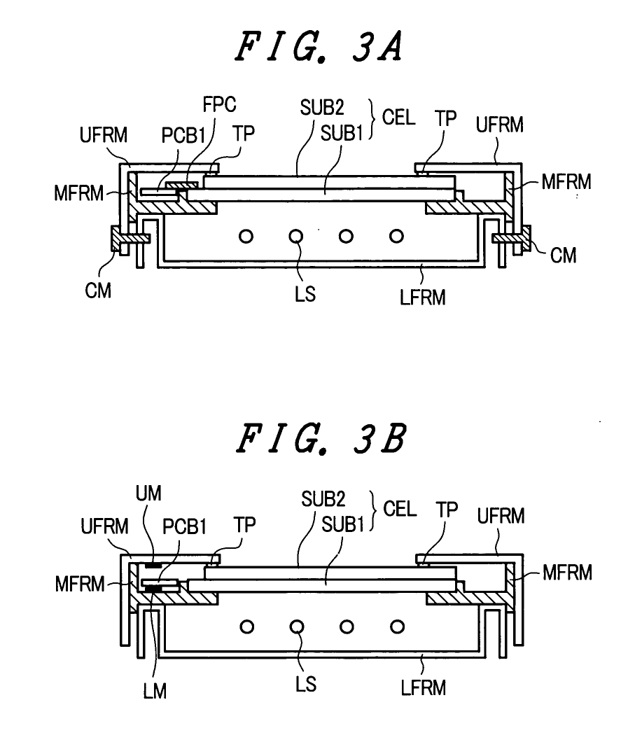

FIGS. 3A and 3B are sectional views which correspond in general to FIGS. 2 and 2B, respectively.

The feature which makes this embodiment different from the embodiment 1 shown in FIGS. 2A and 2B lies in the positions where the upper member UM and the lower member LM are located. In the arrangement of FIGS. 2A and 2B, the upper member UM and the lower member LM are arranged at both a portion where the flexible printed circuit board FPC is present, as shown in FIG. 2A, and a portion where the flexible printed circuit board FPC is not present, as shown in FIG. 2B. On the other hand, this embodiment also adopts a structure in which the upper member UM and the lower member LM are not arranged in the region shown in FIG. 3A, while the upper member UM and the lower member LM are arranged in the region shown in FIG. 3B.

Due to such a constitution, the oscillation mode of the printed circuit board PCB1 can be dispersed, and, hence, resonance can be obviated, whereby a further enhancement of the reliability can be realized.

Further, the number of parts can be reduced, and, hence, the manufacturing cost also can be reduced.

### Embodiment 3

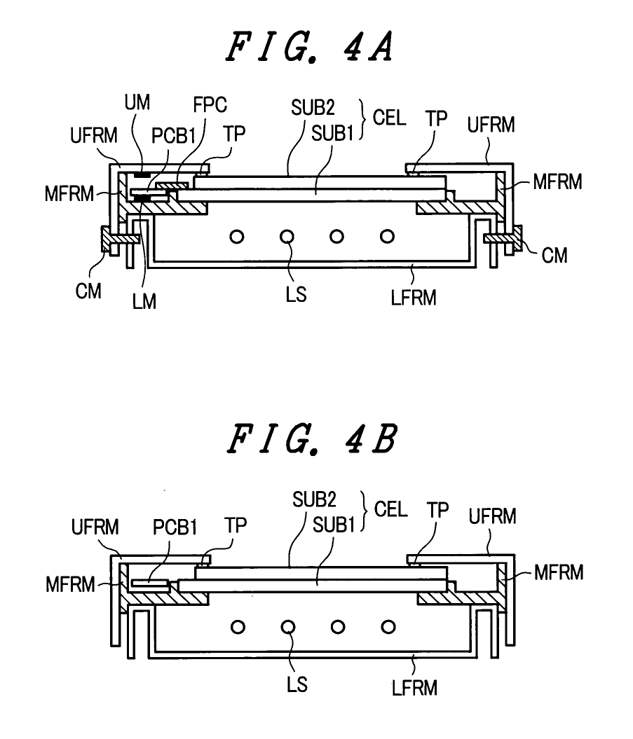

FIGS. 4A and 4B are sectional views which generally correspond to FIGS. 3A and 3B.

The feature which makes this embodiment different from the embodiment 2 shown in FIGS. 3A and 3B lies in the positions where the upper member UM and the lower member LM are located. Contrary to the constitution shown in FIGS. 3A and 3B, in this embodiment, the upper member UM and the lower member LM are arranged in the region shown in FIG. 4A, and the upper member UM and the lower member LM are not arranged in the region shown in FIG. 4B.

Due to such a constitution, the oscillation mode of the printed circuit board PCB1 can be dispersed, and, hence, the resonance can be obviated, whereby further enhancement of the reliability can be realized.

Further, the number of parts can be reduced, and, hence, the manufacturing cost also can be reduced.

### Embodiment 4

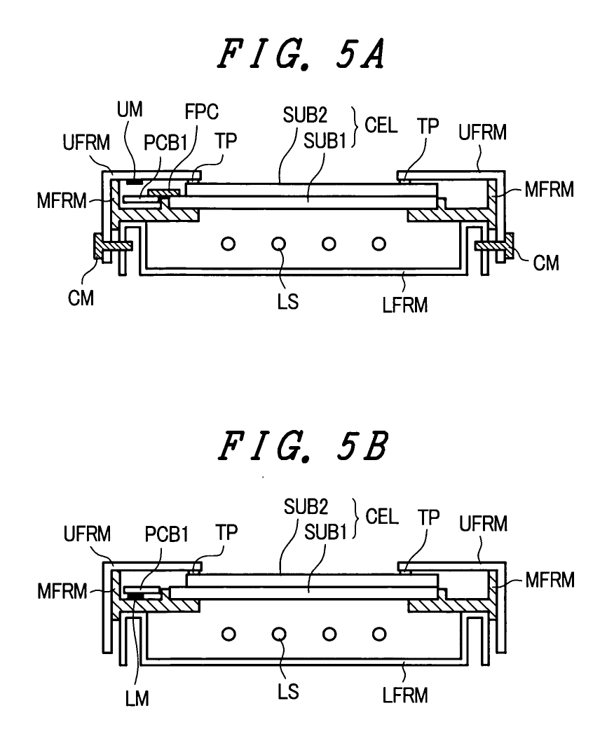

FIGS. 5A and 5B are sectional views which generally correspond to FIGS. 2A and 2B.

The feature which makes this embodiment different from the embodiment 1 shown in FIGS. 2A and 2B lies in the positions where the upper member UM and the lower member LM are located. In this embodiment, the upper member UM and the lower member LM are arranged in a staggered manner.

Due to such a constitution, the oscillation mode of the printed circuit board PCB1 can be dispersed, and, hence, the resonance can be obviated, whereby further enhancement of the reliability can be realized.

Further, the number of parts can be reduced, and, hence, the manufacturing cost also can be reduced.

Here, in the above-mentioned embodiments 1 to 4, it is desirable that the upper member UM and the lower member LM are formed at both positions. However, even when the upper member UM and the lower member LM are formed at either one of these positions, the advantageous effects described above can be obtained to some extent. Accordingly, the upper member UM and the lower member LM may be formed at only one of these positions.

### Embodiment 5

This embodiment is characterized by the application of preferred members to the above-mentioned embodiments 1 to 4. The first characteristic which the upper member UM and the lower member LM are required to satisfy is prevention of the generation of flaws on a surface of the printed circuit board when the upper member UM and the lower member LM are brought into contact with the printed circuit board. The second characteristic which the upper member UM and the lower member LM are required to satisfy is prevention of generation of dust. The third characteristic which the upper member UM and the lower member LM are required to satisfy is a low adhesive strength with the printed circuit board.

The first characteristic is necessary for preventing disconnection of a wiring pattern on a surface of the printed circuit board and a lowering of the reliability, and the second characteristic is necessary for obviating a case that occurs when dust is generated, which dust tends to intrude into the inside of the display region and appear as part of the display.

The third characteristic is necessary for obviating the following case. That is, provided that the adhesive strength or the coefficient of friction of the upper member UM and the lower member LM with the printed circuit board is high, when the printed circuit board and the upper member UM or the lower member LM are brought into contact with each other due to movement of the printed circuit board or the like, caused by a temperature change, vibrations or an impact, for example, the contact state is fixed. Even when the contact state is not fixed, it is possible to assume a region or a structure where the contact state is structurally set as a normal state. In such a case, when the adhesive strength or the frictional coefficient of the upper member UM and the lower member LM with the printed circuit board PCB is high, the upper member UM or the lower member LM strongly suppresses any movement of the printed circuit board PCB.

As a result, the advantageous effect of the present invention, that the thermal expansion of the display element CEL can be obviated by imparting a degree of freedom to the movement of the printed circuit board PCB, is reduced.

Accordingly, it is preferable that the upper member UM and the lower member LM satisfy the above-mentioned three characteristics simultaneously.

The above-mentioned first characteristic is not satisfied by a hard material, such as a metal. As preferred examples, rubber, cloth, sponge or the like can be named. With respect to the second characteristic, a material which has such elements as threads or fibers which become loose is not suitable. As preferred examples, rubber, a special cloth and the like are named. The third characteristic cannot be achieved with usual rubber. This is because usual rubber exhibits a flat surface, and, hence, the contact surface thereof with a counter element material is increased. Further, the fact that the frictional coefficient of rubber per se is large is obvious in view of its application to tires of a motorcycle, as an example. Accordingly, the usual rubber exhibits an excessive frictional coefficient and cannot achieve the third characteristic. Clothes, sponges or the like are named as preferred embodiments in this regard.

In this embodiment, materials which satisfy the above-mentioned three characteristics simultaneously are found and the application of these materials is realized.

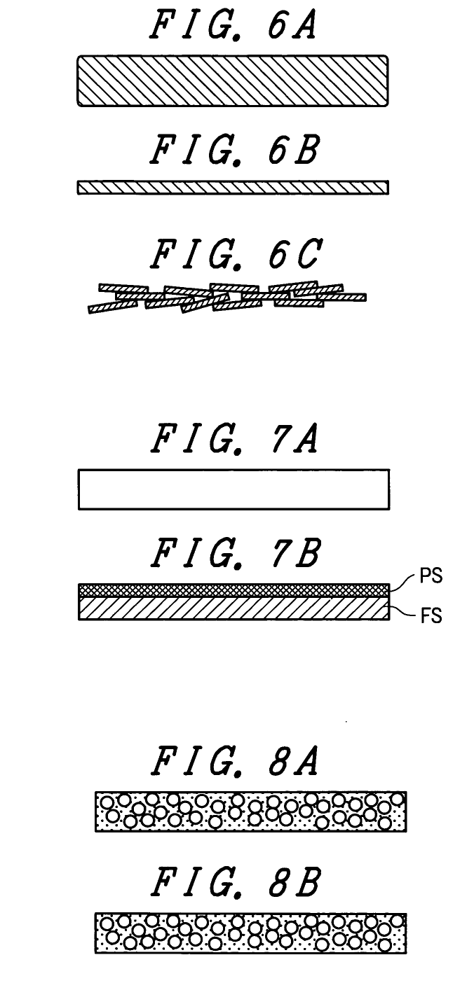

FIG. 6A to FIG. 6C show a first example. In the drawings, FIG. 6A is a plan view, FIG. 6B is a cross-sectional view and FIG. 6C is an enlarged cross-sectional view. The first example is characterized by the use of a nonwoven fabric as a material of either the upper member UM or the lower member LM. A nonwoven fabric is a cloth which is not woven and is formed by melting chemical fibers by heat to form a cloth shape. Since the cloth is not woven and the fibers are melted, there is no possibility that the fibers can become loose. Accordingly, the second characteristic is satisfied with the use of such a material. Further, since nonwoven fabric is a cloth, the first characteristic is satisfied as well. Further, since the fibers are present non-uniformly on a surface of the nonwoven fabric, the contact area on the surface is largely reduced, and, hence, the third characteristic also is satisfied. Still further, a large number of pores are present among the fibers in the nonwoven fabric, and, hence, it is possible to obtain an advantageous effect in that a sound absorption effect can be achieved. That is, a nonwoven fabric can exhibit the advantageous effect that sound which is generated by the movement of the printed circuit board can be absorbed, and, hence, even when the resonance occurs by chance, the resonance sound can be reduced.

In this embodiment, the nonwoven fabric is formed in a rectangular shape and end portions thereof are formed in an arcuate shape. The end portions are considered to have a high possibility that fibers will be peeled off due to contact with other members, compared to other regions thereof. By forming the end portions in an arcuate shape, it is possible to avoid the concentration of the contact with other members only on the distal ends of the corner portions, and, hence, the generation of dust can be structurally prevented.

Further, although the direction of the fibers may be arranged at random, it is preferable that the angle made by the long-side direction of a rectangular shape and the extending direction of the fibers is smaller than the angle made by the end-side direction of the rectangular shape and the extending direction of the fibers. It is more preferable that the extending direction of the fibers is aligned with the long-side direction of the rectangular shape. Due to such an arrangement of the fibers, the contact area between fibers can be further enhanced, and, hence, a further reduction of generation of dust can be realized.

Further, it is preferable that the angle made by the extending direction of the fibers and the extending direction of the printed circuit board PCB, that is, the long-side direction of the printed circuit board PCB, is smaller than the angle made by the extending direction of the fibers and the short-side direction of the printed circuit board PCB. The elongation and shrinkage of the printed circuit board PCB due to heat is large in the long-side direction, which can be attributed to the length per se of the printed circuit board, and, hence, it is important that the movement of the printed circuit board PCB is not interrupted in this direction. Due to such a constitution, the extending direction of the fibers and the direction of thermal change of the printed circuit board PCB become parallel to each other ideally, and, hence, it is possible to provide a more easily movable structure, whereby a further reduction of the frictional coefficient can be realized.

FIG. 7A and FIG. 7B show a second example. In the drawings, FIG. 7A is a plan view and FIG. 7B is a cross-sectional view. This example is characterized by the cross-sectional structure thereof. That is, this example adopts a multilayered structure which is constituted by a layer PS arranged at the printed circuit board PCB side and a layer FS disposed at the frame side which faces the printed circuit board in an opposed manner.

With respect to the characteristics that the layer FS are required to satisfy, since the layer FS is not brought into direct contact with the printed circuit board PCB, the third characteristic is unnecessary for this layer. Accordingly, the usual rubber can be used. That is, it is sufficient that the layer PS, which is brought into contact with the printed circuit board, has the first to third functions. Accordingly, as a whole, this example can exhibit the first to the third functions in a highly combined form.

As an example of a specific constitution, the layer FS may be made of rubber and the layer PS may be made of a nonwoven fabric. Due to such a constitution, it is possible to enhance the elasticity, and, at the same time, it is also possible to realize the above-mentioned first to third characteristics in combination. Further, as an example of another constitution, the layer FS may be made of rubber and the layer PS may be made of a plastic-based thin material which is different from rubber. For example, the layer PS may be made of polyethylene, polypropylene or the like. Here, it is necessary to select a material for the layer PS which exhibits a low frictional coefficient or low elongation and shrinkage property compared to the layer FS. Due to such a selection, it is possible to reduce the interruption of the movement of the printed circuit board PCB by the layer PS compared to the layer FS.

With such a constitution, from another viewpoint, the layer FS also serves as a member which can be used for increasing the total thickness of the structure. That is, when it is difficult to realize the required thickness using a single layer, by adopting a multilayered structure, it is possible to easily realize a constitution which has the required thickness and the first to third characteristics, simultaneously.

FIG. 8A and FIG. 8B show a third example. In the drawings, FIG. 8A is a plan view and FIG. 8B is a cross-sectional view. This example is characterized by the use of a foamed member. Since the foamed member is foamed during the manufacturing process, the foamed member is integrally formed, whereby there is no possibility of generating dust. Further, due to such a structure, the foamed member exhibits a sufficient elongation and shrinkage property, and, hence, it has a cushioning effect. Further, foamed portions appear also on a surface of the foamed member, and, hence, it is possible to provide a constitution in which the contact area with the printed circuit board PCB is reduced.

In this embodiment, foamed rubber is used as the foamed member. With use of the foamed rubber, the upper member UM and the lower member LM can exhibit the first to the third characteristics simultaneously. Further, the upper member UM and the lower member LM can have sound absorbing characteristics comparable to the sound absorbing characteristics of the first example.

A fourth example has a similar structure to that of the example shown in FIGS. 8A and 8B. However, this embodiment uses a material in which granular materials are mixed in a material in place of the use of foamed material.

To be more specific, this example uses rubber in which beads are dispersed. The beads appear partially on a surface portion of the rubber and are brought into contact with the printed circuit board PCB at the bead portions, and, hence, it is possible to largely reduce the contact area with the printed circuit board PCB, whereby this example can exhibit the first to the third characteristics simultaneously.

In this example, to maintain the cushion property and to realize a reduction in the contact area on the surface, it is desirable that a ratio that the beads, that is, the granular materials, occupy in the rubber is set to 1 to 30%. Further, it is desirable that the size of the granular materials is less than one-fourth of the thickness of the rubber. It is more preferable that there exists a difference in thickness of 100 times or more between the rubber and the granular materials such that the size of the rubber is in the order of mm and the size of the granular materials is in the order of μm.

Further, from a viewpoint of flexibility of contact with the printed circuit board PCB, as beads, it is more preferable to use resin-made beads or plastic-made beads, rather than glass-made beads and metal-made beads.

In this embodiment, by applying any one of the members described in connection with the first example to the fourth example to any one of the embodiments 1 to 4, it is also possible to realize the advantageous effects of the embodiments 1 to 4 together with the advantageous effects of this embodiment.

It is particularly desirable to apply any one of the first example, the second example and the fourth example to any one of the embodiments 1 to 4. This is because such application can largely reduce the frictional force on the surface, and, hence, it is possible to enhance the degree of freedom of mobility of the display element CEL.

### Embodiment 6

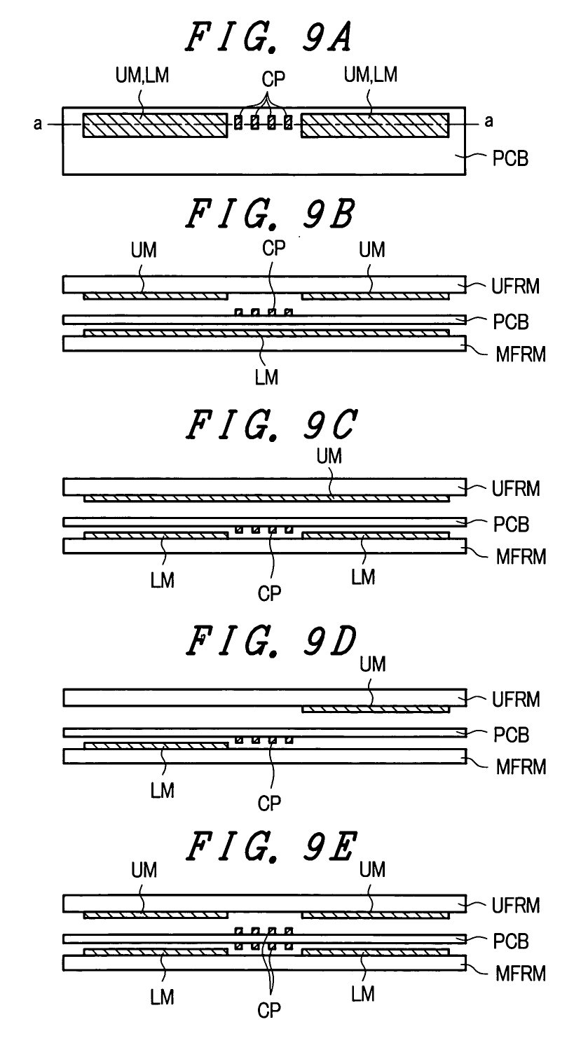

FIG. 9A to FIG. 9E are views which illustrate layout examples of the upper members UM and the lower members LM, wherein this embodiment is applied in combination with one or a plurality of the embodiments 1 to 5. This embodiment relates to the layout of the upper members UM and the lower members LM when elements, such as chip capacitors or chip resistances, are mounted on the printed circuit board.

FIG. 9A is a planar layout example. The printed circuit board PCB may be constituted of either one of or both the PCB1 and PCB2. The chip members CP are mounted on a portion of the printed circuit board PCB. In this embodiment, the upper members UM or the lower members LM are arranged such that they avoid the region where the chip members CP are formed. This is because, when a state in which the upper members UM or the lower members LM and the chip members CP are brought into contact with each other is maintained, the chip members CP come into contact with either one of the upper members UM or the lower members LM; and, hence, the movement of the printed circuit board PCB is suppressed eventually, whereby alleviation of the stress is suppressed and the advantageous effect of the present invention is decreased.

FIG. 9B to FIG. 9E are views which show the cross-sectional structures taken along a line a-a in FIG. 9A.

In FIG. 9B, the chip members CP are arranged on an upper surface of the printed circuit board PCB. Further, the upper members UM which are formed on the upper frame UFRM are arranged in a divided form to avoid the region where the chip members CP are formed.

In FIG. 9C, the chip members CP are arranged on a lower surface of the printed circuit board PCB. Further, the lower members LM which are formed on the lower frame LFRM are arranged in a divided form to avoid the region where the chip members CP are formed.

In FIG. 9D, the chip members CP are arranged on a lower surface of the printed circuit board PCB. Further, the lower members LM which are formed on the lower frame LFRM and the upper members UM which are formed on the upper frame UFRM are arranged to avoid the region where the chip members CP are formed, and, at the same time, they are disposed in an alternating manner.

In FIG. 9E, the chip members CP are arranged on a lower surface and an upper surface of the printed circuit board PCB. Further, the lower members LM which are formed on the lower frame LFRM and the upper members UM which are formed on the upper frame UFRM are arranged to avoid the region where the chip members CP are formed. In mounting the chip members CP on both surfaces, that is, on the upper and the lower surfaces of the printed circuit board PCB, it is desirable to form regions where the chip members CP are arranged in a concentrated manner on both upper and lower surfaces. Due to such a constitution, it is possible to reduce the areas necessary for forming the chip members CP in a plane. This leads to a lowering of the cost. Further, it is possible to increase the layout area of the upper members UM and the lower members LM.

### Embodiment 7

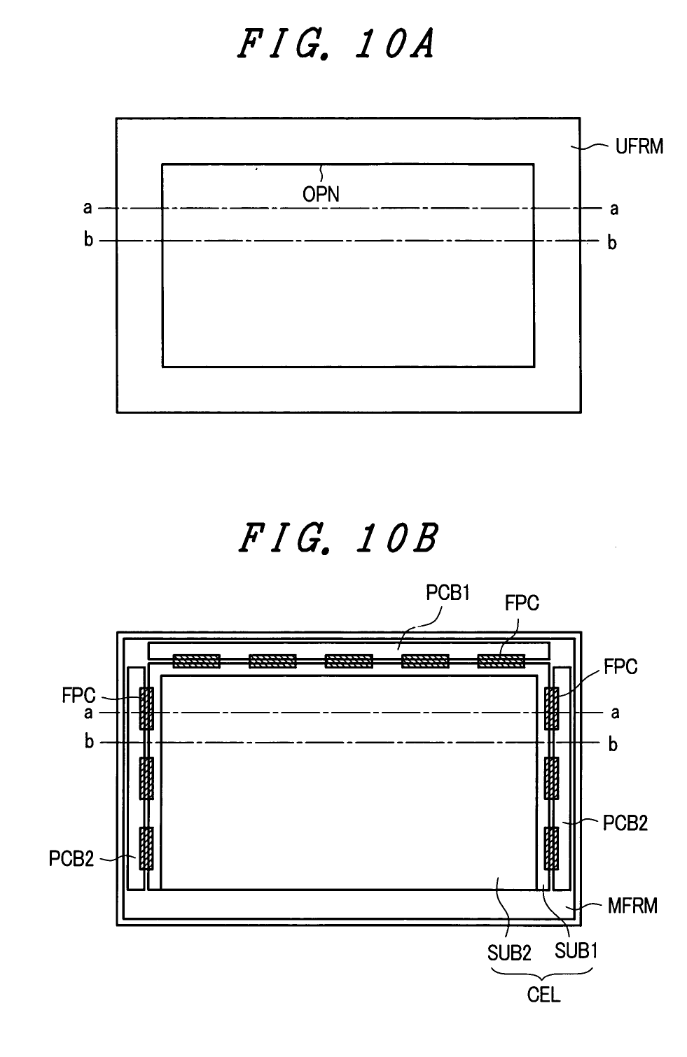

FIG. 10A and FIG. 10B are views which generally correspond to FIG. 1A and FIG. 1B, wherein FIG. 10A is a plan view showing the upper frame UFRM and FIG. 10B is a plan view which shows the intermediate frame MFRM in a state in which the upper frame UFRM is removed. The constitution which makes this embodiment different from the embodiment shown in FIGS. 1A and 1B lies in the fact that printed circuit boards PCB2 are arranged at both the left and right sides.

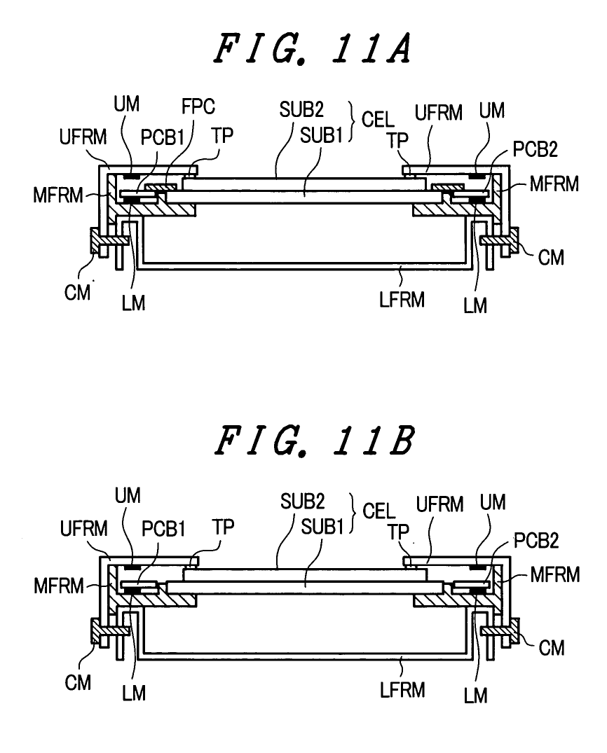

FIG. 11A and FIG. 11B show cross-sectional structures taken along a line a-a and a line b-b in FIGS. 10A and 10B, respectively. The upper member UM and the lower member LM are arranged above and below the left and right printed circuit boards PCB2.

In this embodiment, by applying the technical concepts of the embodiments 1 to 6 to the printed circuit board PCB2 sides, it is possible to realize advantageous effects substantially equal to those obtained by the above-mentioned respective embodiments also at the printed circuit board PCB2 sides.

### Embodiment 8

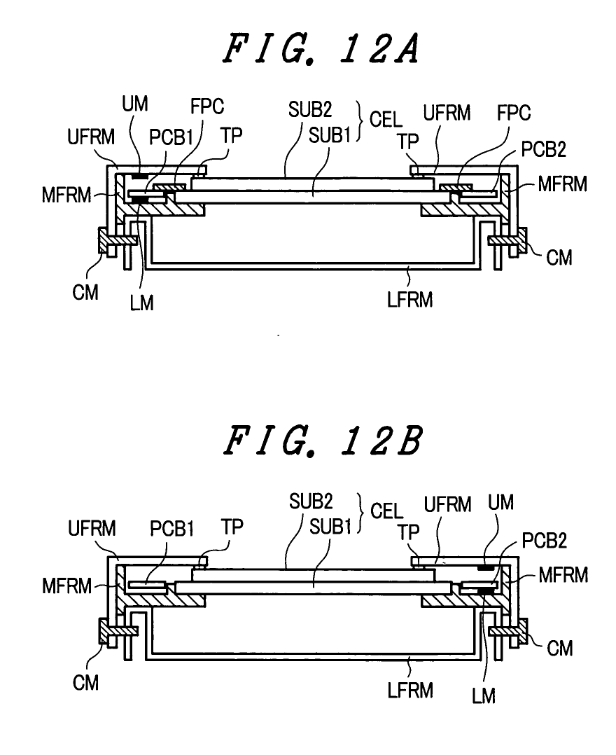

FIG. 12A and FIG. 12B are views which generally correspond to FIG. 11A and FIG. 11B. The feature which makes this embodiment different from the constitution shown in FIG. 11A and FIG. 11B lies in the fact that the regions where the upper member UM is formed and the regions where the lower member LM are formed are alternately arranged at both sides, that is, at the left and the right sides. In FIG. 12A, the upper member UM and the lower member LM are arranged at the left side as seen in the drawing; while, in FIG. 12B, the upper member UM and the lower member LM are arranged at the right side as seen in the drawing. Due to such a constitution, the resonance can be reduced.

In a display device for a large-sized TV, speakers are arranged at both sides, that is, on the left and right sides in many cases. Further, even if the sounds come from the stereo broadcasting, a large number of common components are contained in the sounds from both speakers. This becomes a cause of the generation of resonance. By arranging the region where the upper member UM is formed and the region where the lower member LM is formed alternately at the left and right sides, the resonance attributed to speakers which are arranged at the left and right sides can be suppressed, whereby the reliability can be further enhanced.

### Embodiment 9

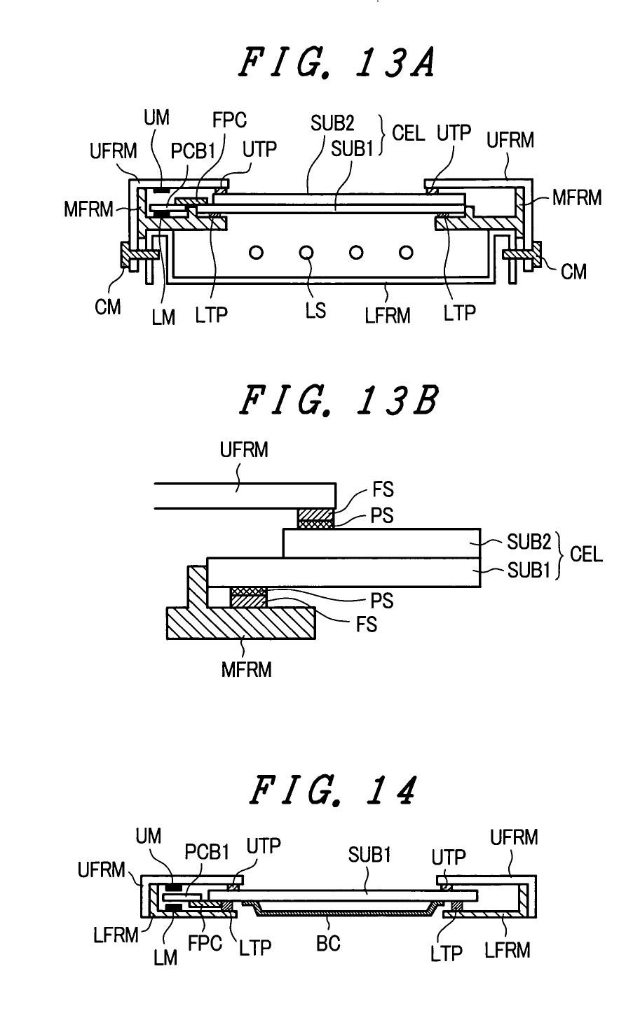

FIG. 13A and FIG. 13B are views showing an embodiment which is applicable in combination with at least any one of the above-mentioned embodiments 1 to 4 or 6 to 8, or it may be employed in a single form.

This embodiment is characterized in that the structure includes at least either one of upper spacers UTP, which are arranged between the display element CEL and the upper frame UFRM, and lower spacers LTP, which are arranged between the display element CEL and the intermediate frame MFRM, and, as a member thereof, any of the members described in connection with the embodiment 5 may be used.

To alleviate the stress generated in the display element attributed to a change of length caused by the expansion and shrinkage of the display element CEL and the printed circuit board PCB due to heat, an advantageous effect can be expected by constituting the display element CEL such that the mobility of the display element CEL per se is enhanced in addition to the enhancement of the mobility of the printed circuit board. For this purpose, it is effective to provide at least either the upper spacers UTP, which are arranged between the display element CEL and the upper frame UFRM, or the lower spacers LTP, which are arranged between the display element CEL and the intermediate frame MFRM, and to employ any of the members disclosed in connection with the embodiment for the upper spacers UTP or the lower spacers LTP. This is because, with such a constitution, in the same manner as explained in detail in conjunction with the embodiment 5, the movement of the display element CEL can be facilitated.

As one example, FIG. 13A shows an arrangement in which both the upper spacers UTP, which are arranged between the display element CEL and the upper frame UFRM, and the lower spacers LTP, which are arranged between the display element CEL and the intermediate frame MFRM, are provided. An enlarged view showing the vicinity of the upper spacer UTP and the lower spacer LTP is shown in FIG. 13B. This embodiment uses the member explained in connection with the example 2 of embodiment 5, and the surface PS at the printed circuit board side in the embodiment 5 is brought into contact with the display element CEL. Due to such a constitution, the mobility of the display element CEL is enhanced.

It is needless to say that any of the members described in the example 1 to example 4 in the embodiment 5 may be used.

Further, both the upper spacers UTP and the lower spacers LTP are provided in FIG. 13A. However, only one of the upper spacer UTP and the lower spacer LTP need be provided. This is because that the advantageous effect can be obtained to a certain extent using such a constitution. Further, it may be constituted such that one of the spacers is formed of a member described in connection with the embodiment 5 and the other spacer is formed of ordinary rubber. This is because an advantageous effect to a certain extent can be obtained compared to a case in which strong fixing is performed using adhesive rubber.

According to the structure of this embodiment, the movement of the display element CEL in the left and right directions is restricted by a projecting portion formed on the intermediate frame MFRM. Therefore, even if this embodiment is applied to a display device, there exits a limit with respect to the displacement of the display element CEL from a given position.

Further, with respect to the movement of the display element CEL in the vertical direction, the display element CEL is held structurally at a proper position by means of the upper frame UFRM and the intermediate frame MFRM by way of the upper spacer UTP and the lower spacer LTP. Accordingly, the structure of this embodiment can realize only the stress alleviation effect.

### Embodiment 10

FIG. 14 shows a modification of the above-mentioned respective embodiments. The above-mentioned respective embodiments exemplify structures in which the display element CEL is provided with two substrates SUB1 and SUB2. That is, these embodiments are directed to an example in which the structure is used for a liquid crystal display element, a field emission display (FED), a plasma display (PDP) or the like. However, it is not always necessary for the structure to have two substrates, and the present invention is also applicable to a display element CEL which is constituted of one substrate in the same manner. This embodiment shows a structural example which is suitable for such a display element. This embodiment is particularly suitable for a self luminous element, such as an organic EL display element or an inorganic EL display element.

In this embodiment, a substrate SUB1 which has wiring and thin film transistors TFT mounted thereon and has a light emitting function is provided. On a back surface of the substrate SUB1, a back cavity BC is provided to protect the light emitting surface from the external environment. The back cavity BC may be formed of a metal tube, resin, glass substrate or a film. At least one end portion of the substrate SUB1 is electrically connected with the printed circuit board PCB1 via a flexible printed circuit board FPC. An upper frame UFRM is arranged above the printed circuit board PCB1. Further, a lower frame LFRM is arranged under the printed circuit board PCB1. The upper frame UFRM and the lower frame LFRM are connected to and fixed to each other. A display element SEL is supported by the upper frame UFRM and the upper member UTP as well as by the lower frame LFRM and the lower member LTP. To these members UPT, LTP, a technical concept substantially equal to the technical concept used in the above-mentioned respective embodiments is applicable, and, hence, this embodiment can realize advantageous effects substantially equal to the advantageous effects obtained by these embodiments. An upper member UM arranged on the upper frame UFRM is formed above the printed circuit board PCB1 and a lower member LM arranged on the lower frame UFRM is formed below the printed circuit board PCB1. With this constitution, a technical concept substantially equal to the technical concepts used in the above-mentioned respective embodiments is also applicable to this embodiment, and, hence, this embodiment can realize advantageous effects similar to the advantageous effects obtained by these embodiments. It may be possible to use only either one of the upper member UM or the lower member LM. Further, with respect to the layout of these members UM and LM, various constitutions are considered as described in the above-mentioned respective embodiments.

In this embodiment, an opening portion is formed in the lower frame LFRM at the back cavity BC portion. Due to such a constitution, it is possible to prevent an increase in the thickness of the lower frame LFRM.

### Embodiment 11

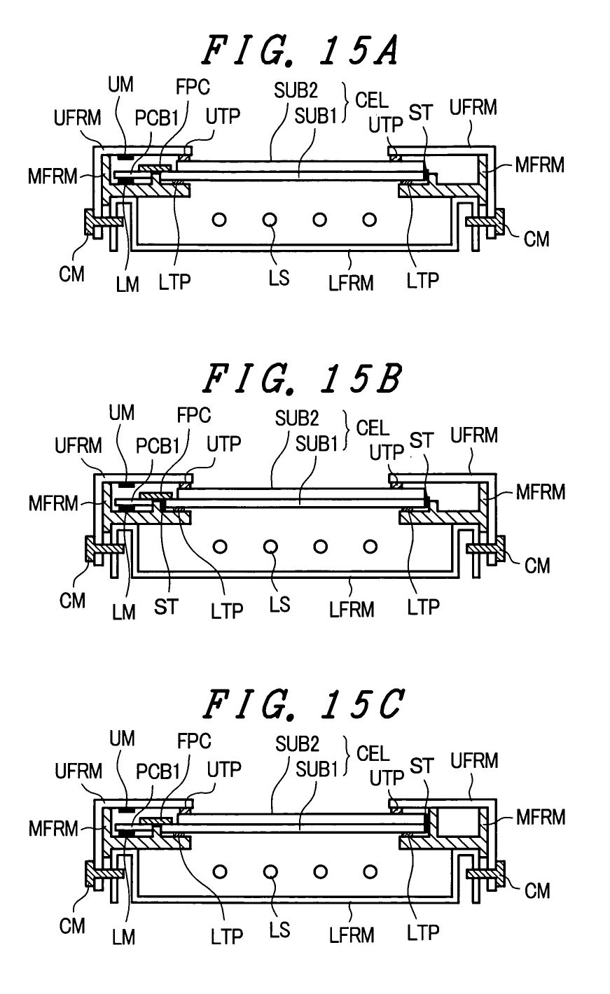

FIG. 15A to FIG. 15C are sectional views which generally correspond to the view in FIG. 13A, and FIG. 15A to FIG. 15C cross-sectional views taken along the line a-a in FIG. 1A and FIG. 1B. The embodiment 11 shown in FIG. 15A is characterized in that a smoother ST is formed on the display element CEL or other member at a position where an end portion of the display element CEL faces the other member (a portion where an upward projecting portion formed on an intermediate frame MFRM and the end portion of the display element CEL face each other) for improving the sliding performance. Hereinafter, an explanation will be given concerning an example in which an intermediate frame MFRM constitutes the other members.

When the thermal expansion coefficients of the display element CEL and the intermediate frame MFRM do not completely agree with each other, a difference in the degree of expansion and shrinkage is generated due to a temperature change in both the display element CEL and the intermediate frame MFRM. In this case, a stress is generated between the intermediate frame MFRM and the display element CEL, and the contrast or the brightness of the display element is influenced by the stress. Since the display element CEL is mainly formed of glass and the intermediate frame MFRM is formed of a metal or resin, the generation of the difference in thermal expansion coefficient is unavoidable.

It is expected that, even when a space is formed between the display element CEL and the intermediate frame MFRM at a room temperature of approximately 20° C., both the display element CEL and the intermediate frame MFRM will expand in response to elevation of the temperature and will be brought into contact with each other. In this case, the freedom of movement of the display element CEL is limited on a contact surface, and the image quality is ill-affected by the difference in stress between the display element CEL and the intermediate frame MFRM.

Further, when the display element CEL is particularly large, the weight of the display element per se will be large. Although the display element is arranged in a plane as seen in FIG. 15A, in actual use of the display element of the type which is incorporated in a thin TV or a thin monitor, the display element is usually in an erected posture during use. Accordingly, it is necessary to support the weight of the display element CEL within the display device and, especially, the weight thereof is concentrated on a portion which represents a lower side of the display device when the display device is erected. As one example, in FIG. 15A, assume that the right side of device as seen in the drawing becomes the lower side when erected. In such a case, it is easily expected that, even if the display element CEL and the intermediated frame MFRM are separated from each other before shipment, due to the use thereof for a long period extending over several years, the display element CEL will gradually move toward the lower side due to its own weight until the display element CEL comes into contact with the intermediate frame MFRM.

On the other hand, to limit the movement of the display element CEL in the left-and-right direction as seen in the drawing, it is desirable to bring the display element CEL into contact with the intermediate frame MFRM at least on one side of the display element CEL. Due to such a constitution, the correct positioning can be realized. For this purpose, it may be possible to provide a constitution in which the display element CEL and the intermediate frame MFRM are preliminary brought into contact with each other.

In any one of the above-mentioned respective cases, contact between the display element CEL and the intermediate frame MFRM occurs, and, hence, the freedom of movement of the display element CEL is restricted on the contact surface, whereby an image quality is influenced by the difference in stress between the display element CEL and the intermediate frame MFRM caused by a temperature change or the like.

Further, when the weight of the display element CEL is applied to the intermediate frame MFRM when the display device is disposed with an erected posture or the like, the own weight of the display element CEL becomes a cause of the generation of stress.

Accordingly, this embodiment is characterized in that smoothers ST are provided at portions where end portions of the display element CEL and the intermediate frames MFRM face each other. Due to such a constitution, when the display element CEL and the intermediate frame MFRM are brought into contact with each other, the sliding performance of the display element CEL is improved, and, hence, the degree of freedom of movement of the display element CEL is increased, whereby the stress can be alleviated.

As an example of the smoother ST, a smoother made of a plastic member is desirable. The smoother may be made of ordinary plastic, a tape made of cellophane material, a tape made of polyethylene material or PET (polyethylene terephthalate) material. Further, the members which have been described in conjunction with FIG. 6 or FIG. 7 may be used. These smoothers ST are fixed to either one of the display element CEL or the intermediate frame MFRM using an adhesive layer, for example. Due to such a constitution, a non-fixed surface functions as a smoother, which improves the sliding performance. Considering the easiness of the mounting operation, it is more desirable to set the intermediate frame MFRM side as a fixing side.

This embodiment can further alleviate the stress in combination with the above-mentioned respective embodiments, so that a display device having a high image quality and high reliability can be realized. It is needless to say that the concept of providing a smoother ST, which improves the sliding performance with respect to the display element CEL or other member relative to the portion where the end portion of the display element CEL faces the other members shown in this embodiment, may be used in a single form. This is because, even when this embodiment is used in a single form, the stress alleviation effect explained in conjunction with this embodiment can be obtained.

Further, in connection with this embodiment, an explanation was made with respect to the case in which the smoother ST is provided between the display element CEL and the intermediate frame MFRM. However, the smoother ST may be provided between the display element CEL and the other members. Further, the smoother ST may be applied at the other side of the display element.

### Embodiment 12

FIG. 15B is a view which generally corresponds to FIG. 15A. In this embodiment, the smoothers ST are formed on the intermediate frames MFRM at positions which correspond to both ends of the display element CEL. Due to such a constitution, this embodiment can cope with more versatile situations, including a case in which the arrangement direction of the display element CEL is subject to change, such as in the case where the display element CEL is incorporated in a thin type TV or a monitor or the like, and, hence, a high image quality and high reliability can be realized in a stable manner.

### Embodiment 13

FIG. 15C is a view which generally corresponds to FIG. 15A. In this embodiment, the height of the intermediate frame MFRM at a portion where the intermediate frame MFRM faces the display element is set to be higher than the height of the display element CEL. Due to such a constitution, the area of the smoother ST can be increased, and, hence, the smoother ST can further contribute to the alleviation of stress.

Further, at the time of forming the smoother ST on the intermediate frame MFRM side, the laminating operation can be performed easily, and, hence, the productivity can be enhanced.

### Embodiment 14

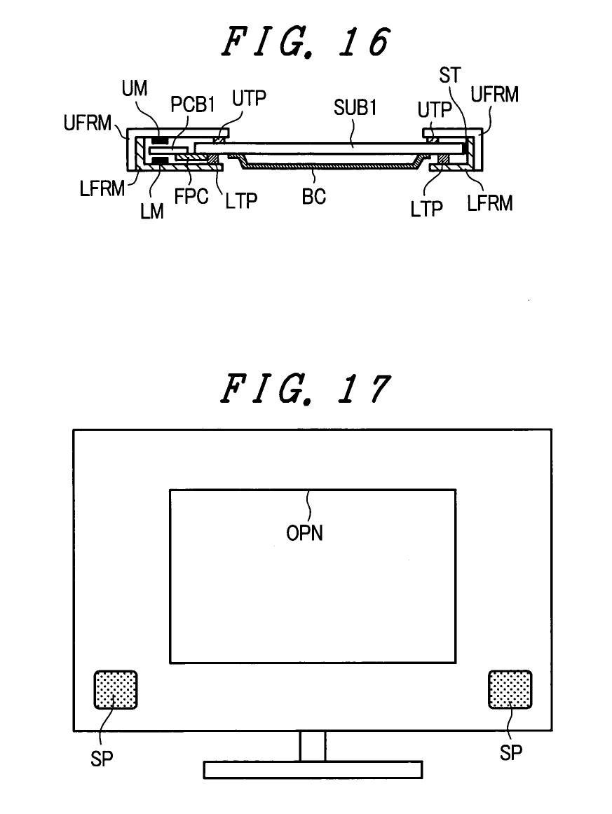

FIG. 16 shows an example of a case in which the concept of the embodiment 13 is applied to a display device as shown in FIG. 14. The lower frame LFRM and the display element CEL are arranged to face each other by way of the smoother ST.

In this manner, the technical concepts of the embodiments 11A to 13A are applicable to members other than the intermediate frame MFRM and to a self-luminous type display element CEL.

Further, the technical concepts explained in conjunction with the embodiments 11A to 14, which provide a smoother, may be applied to the upper member UM, the lower member LM, the upper spacer UTP or the lower spacer LTP, which has been explained in conjunction with the embodiments 1A to 10B, to provide the function of the smoother ST to these members. This is because the alleviation of stress can be realized with respect to respective mounting positions of these members. Further, by providing the function of the smoother ST in combination with the other functions or in a single form to the upper member UTP or the lower member LTP, it is possible to realize a constitution in which the stress can be alleviated by arranging the smoother between the support member and the display element.

### Embodiment 15

FIG. 17 shows a case in which the display device having the constitutions according to the above-mentioned respective embodiments is applied to a thin type TV, a thin type monitor or the like.

An opening portion OPN represents an area where a display region is formed. Further, speakers SP are provided at both sides of the opening portion OPN. Due to such a constitution, the vibrations or the sound pressure of the speakers SP are applied to the display device CEL. Therefore, depending on the information or volume of sound reproduced when the display device is used, there exists a concern that vibrations or a resonance will be generated and applied to the display device.

By applying the display device described in conjunction with any of the embodiments 1 to 14 of the present application to the display device of such a thin type TV or monitor, the generation of such a phenomenon can be suppressed and the reliability of the display device can be enhanced.

Further, when vibrations or resonance is generated in the display device, since the sound is recognized from the outside, there exists a fear that a user will feel a discomfort and the quality of the device will be degraded. According to the features disclosed in conjunction with the embodiments 1 to 14, it is also possible to realize a vibration suppressing effect and a sound absorption effect in the inside of the device, which can reduce the discomfort that the user feels. Accordingly, as a whole, a further enhancement of the quality can be achieved.

As can be clearly understood from the foregoing explanation, according to the present invention, it is possible to provide a display device in which the stress caused by the difference in thermal expansion coefficients between the cell and the printed circuit board can be alleviated and a lowering of the display quality can be suppressed.

Further, it is also possible to provide a display device in the influence of a vibration or resonance can be reduced and high quality can be exhibited.

What is claimed is:

1. A display device comprising:
a display element;
a printed circuit board which is arranged on a periphery of the display element and a flexible printed circuit board which connects the display element and the printed circuit board;
wherein the display device includes a first frame which is arranged above the printed circuit board and a second frame which is arranged below the printed circuit board, and
the display device further includes buffer members which are fixed to either one of the first frame or the second frame and face the printed circuit board.

2. A display device according to claim 1, wherein the buffer members are alternatively arranged on an upper side and a lower side of the printed circuit board.

3. A display device according to claim 1, wherein the printed circuit board includes two members which extend in parallel and the buffer members are alternately arranged with respect to the left and the right members.

4. A display device according to claim 1, wherein the printed circuit board includes two members which extend in parallel and the buffer members are alternately arranged with respect to the left and the right members.

5. A display device according to claim 1, wherein the display device includes chip members which are arranged on an upper surface or a lower surface of the printed circuit board and the buffer members are arranged while avoiding regions for forming the chip members.

6. A display device comprising:
a display element and a printed circuit board which is connected with the display element by a flexible printed circuit board;
wherein the display device includes a first frame which is arranged above the display element and a second frame which is arranged below the display element, and
the display device includes buffer members which are fixed to either one of the first frame or the second frame and are brought into contact with the display element.

7. A display device comprising:
a display element;
a printed circuit board which is arranged on a periphery of the display element and a flexible printed circuit board which connects the display element and the printed circuit board and the display device;
wherein the printed circuit board is movable and an amount of the movement is restricted.

8. A display device according to claim 1, wherein the buffer members are made of nonwoven fabric.

9. A display device according to claim 8, wherein the buffer members have an elongated rectangular shape and end portions thereof are formed in an arcuate shape.

10. A display device according to claim 8, wherein the extending direction of fibers of the buffer members is at the extending direction side of the printed circuit board.

11. A display device according to claim 1, wherein the buffer member has the multilayered structure and a frictional coefficient of surfaces of the buffer members which opposingly faces the printed circuit board or the display element is smaller than a frictional coefficient of surfaces of the buffer members which are opposite to the opposingly facing surface.

12. A display device according to claim 1, wherein the buffer member has the multilayered structure and surfaces of the buffer members which opposingly faces the printed circuit board or the display element is made of a material having an elongation and shrinkage property lower than an elongation and shrinkage property of surfaces of the buffer members which are opposite to the opposingly facing surface.

13. A display device according to claim 1, wherein the buffer member has the multilayered structure and surfaces of the buffer members which opposingly faces the printed circuit board or the display element is made of plastic and surfaces of the buffer members which are opposite to the opposingly facing surface is made of rubber.

14. A display device according to claim 1, wherein the buffer members are made of a foamed member.

15. A display device according to claim 1, wherein the buffer members are made of rubber which mixes beads in the inside thereof.

16. A display device according to claim 6, wherein the buffer members are made of nonwoven fabric.

17. A display device according to claim 16, wherein the buffer members have an elongated rectangular shape and end portions thereof are formed in an arcuate shape.

18. A display device according to claim 16, wherein the extending direction of fibers of the buffer members is at the extending direction side of the printed circuit board.

19. A display device according to claim 6, wherein the buffer member has the multilayered structure and a frictional coefficient of surfaces of the buffer members which opposingly faces the printed circuit board or the display element is smaller than a frictional coefficient of surfaces of the buffer members which are opposite to the opposingly facing surfaces.

20. A display device according to claim 6, wherein the buffer member has the multilayered structure and surfaces of the buffer members which opposingly faces the printed circuit board or the display element is made of a material having an elongation and shrinkage property lower than an elongation and shrinkage property of surfaces of the buffer members which are opposite to the opposingly facing surfaces.

21. A display device according to claim 6, wherein the buffer member has the multilayered structure and surfaces of the buffer members which opposingly faces the printed circuit board or the display element is made of plastic and surfaces of the buffer members which are opposite to the opposingly facing surface is made of rubber.

22. A display device according to claim 6, wherein the buffer members are made of a foamed member.

23. A display device according to claim 6, wherein the buffer members are made of rubber which mixes beads in the inside thereof.

24. A display device comprising:
a display element and support members which are arranged on a periphery of the display element;
wherein smoothers are provided between the display element and the support members.

25. A display device according to claim 24, wherein the smoothers are provided between end portions of the display element and the support members.

26. A display device according to claim 24, wherein a height of surfaces of the support members which opposingly face the display element is set larger than a height of the display element, and the smoothers are arranged at the support member side.

27. A display device according to claim 24, wherein the smoothers are formed on a lower side of the display device.

28. A display device according to claim 24, wherein materials of the display element and the support members are different from each other.

29. A display device according to claim 24, wherein the smoothers are formed in a tape shape.
